(19) United States
(12) Patent Application Publication
(10) Pub. No.: US 2013/0265448 A1
(43) Pub. Date: Oct. 10, 2013

(54) Analyzing Human Gestural Commands

(71) Applicant: Wenlong Li, Beijing (CN)

(72) Inventor: Wenlong Li, Beijing (CN)

(21) Appl. No.: 13/854,236

(22) Filed: Apr. 1, 2013

(30) Foreign Application Priority Data
Apr. 1, 2012 (CN) PCT/CN2012/000427

(51) Int. Cl. H04N 5/44; G06F 3/00; G06K 9/00

(52) U.S. Cl. CPC H04N 5/4403; G06K 9/00335; G06F 3/005
USPC 348/207.1; 382/118

(57) ABSTRACT

In some embodiments, facial recognition can be used to aid in the association of human gestural commands with particular users and particular computing devices associated with those users. This can be used for example to control television viewing in one embodiment and to enable the users to provide gestural commands to have information about the television program from the television sent to their associated computing devices. In addition, the facial recognition may assist in distinguishing commands from one user from those of another user, avoiding the need to require that the users remain within fixed positions associated with each user.

### CROSS-REFERENCE TO RELATED APPLICATIONS

This application claims priority to PCT/CN2012/000427, filed on Apr. 1, 2012.

### BACKGROUND

This relates generally to computer systems and particularly to computer systems operated in response to human gestural commands.

A human gestural command is any identifiable body configuration which a computer may understand, for example by training, to be a particular command to take a particular action. For example, hand gestures such as thumbs up or thumbs down are known to be human gestural commands. Generally these gestural commands are recognized by recording commands in a set-up phase using a camera associated with a computer. Then image analysis is used to identify the nature of the command and to associate the imaged command with a trained response.

For example, the Kinect computer system available from Microsoft Corp. allows users to make movements which the computer understands as game inputs. As an example, a user can make the motion normally associated with rolling a bowling ball in bowling and the computer can analyze the movement to determine the effect a real bowling ball, thrown as indicated, would have had in a real bowling alley.

### BRIEF DESCRIPTION OF THE DRAWINGS

Some embodiments are described with respect to the following figures:

FIG. 1 is a perspective view of one embodiment of the present invention;

FIG. 2 is a system depiction for one embodiment;

FIG. 3 is a flow chart for a sequence performed on a television receiver in accordance with one embodiment;

FIG. 4 is a flow chart for a sequence for setting up the television receiver to perform the sequence shown in FIG. 3 in accordance with one embodiment; and

FIG. 5 is a sequence performed by a mobile device according to one embodiment.

### DETAILED DESCRIPTION

By enabling a computer system to analyze human gestural commands, additional information may be obtained which may further facilitate the user friendliness of gestural command based systems. For example, systems that require users to stand in particular positions in order to provide the commands may create an awkward user-computer interface. Users may forget to stand in the predesignated areas and requiring that they stay in position makes it harder for them to provide the desired gestural information.

Thus, it would be desirable to have better ways for enabling computer systems to use human gestural commands. In some embodiments, user hand gestural commands may be associated with a particular user using facial recognition.

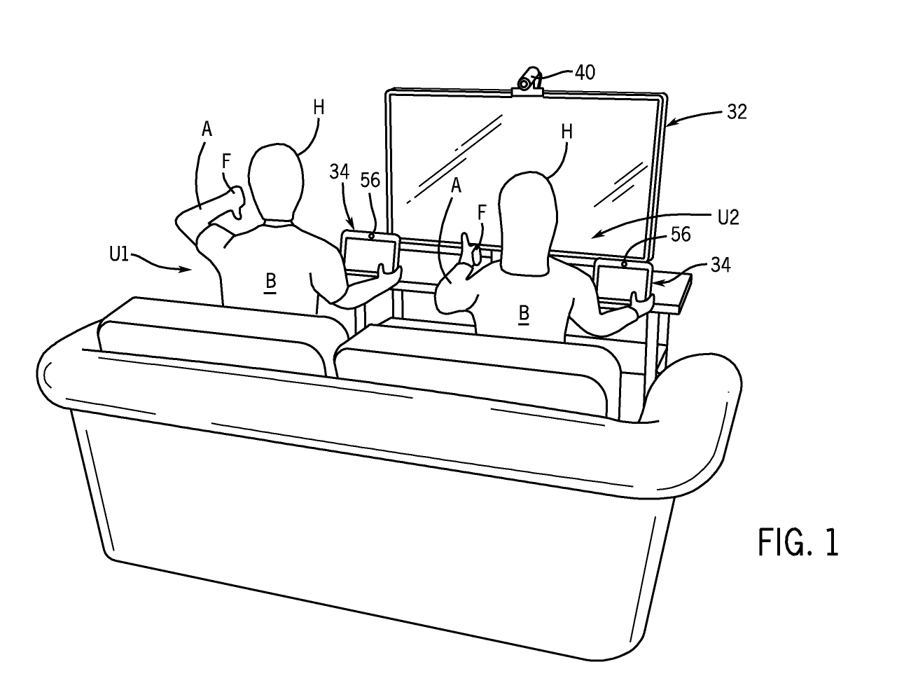

Thus referring to FIG. 1, a living room set-up is shown to illustrate one possible mode of operation of one embodiment of the present invention. In this case more than one user, for example two users (U1 and U2), are interacting using gestural commands with a single computer device 32. In one embodiment the computer device may be a television receiver with a processor. That television receiver may be equipped with a camera 40 to image users viewing the television receiver. Conveniently, a camera associated with the television receiver may image persons watching the television receiver or playing a game displayed on the television receiver.

If the user U1 on the left in FIG. 1 raises his right hand to make a hand gestural command and the user U2 on the right side raises her left hand to make a hand gestural command, the system may be unable to determine which user made each command. This problem can arise in a number of different situations. In connection with the play of the game, a gestural command may become associated with the wrong player, making the game unworkable. In connection with a television system in which information may be provided back to particular users making particular gestural commands, it is important to know which user made the gestural command. For example, a user may make a gestural command in order to receive special content on a mobile device associated with that user.

Examples of such command and feedback systems may include enabling one user to receive television content now displayed on the television receiver on his or her mobile device 34. Another example may be enabling the user to receive a screen shot on a mobile device from the ongoing television display. Still another example is to allow a user to receive different content on a mobile device from that currently displayed on the receiver. In some embodiments different hand commands may be provided for each of these possible inputs.

In some embodiments a pre-defined hand gestural command may be used to start gesture analysis. This simplifies the computer's gestural analysis task because it only needs to monitor for one gesture most of the time.

Each of the mobile devices 34 may also be associated with a camera 56. This may further assist in associating particular users with particular commands since a user's mobile device may provide digital photograph which is then transferred to the television. The television can then compare a picture it receives from the mobile device with a picture captured of a user by the television's camera. The television can associate each user depicted in its captured image with a particular mobile device that sent the television a message with the captured user image. This further facilitates associating various commands with particular mobile devices and/or users.

Thus as used herein, “associating a particular command with a particular user”, includes associating a command with the user as imaged as well as associating the command with a mobile device associated with that user.

In the case illustrated in FIG. 1, the users U1 and U2 are sitting on a couch close to each other. A hand gesture of thumbs down indicated at F is made by the user U1 and a hand gesture of thumbs up is indicated by the hand F of the user U2. The hands F are connected by arms A to bodies B of each user. Each user's head is indicated by H. Thus in some embodiments, video analytics can be used to detect the command indicated by the user's hand F and to tie that command to a particular user U1 or U2. This may be done by identifying the arm A connected to the hand F and then the body B connected to the arm A. Finally the body B is connected to the user's head H and particularly the user's face. Facial recognition may be used to identify the user and then to tie a particular user and his or her commands to information sent from or to a particular user's mobile device 34.

In some cases, the camera 56 associated with the mobile device 34 may be used to further aid in identifying a user and distinguishing user U1 from user U2. For example the camera 56 may be used to image the user's face and to send a message to the computer device 32. Then the computer device 32 can compare an image it takes and an image it receives from the mobile device 34 to confirm the identification of a user and further to associate the user and his facial image with a particular mobile device 34. Of course, the same techniques can be used to disambiguate commands from multiple users.

Examples of mobile devices that may be used include any mobile device that includes a camera including a cellular telephone, a tablet computer, a laptop computer or a mobile Internet device. However, the present invention could also be used with non-mobile computers as well.

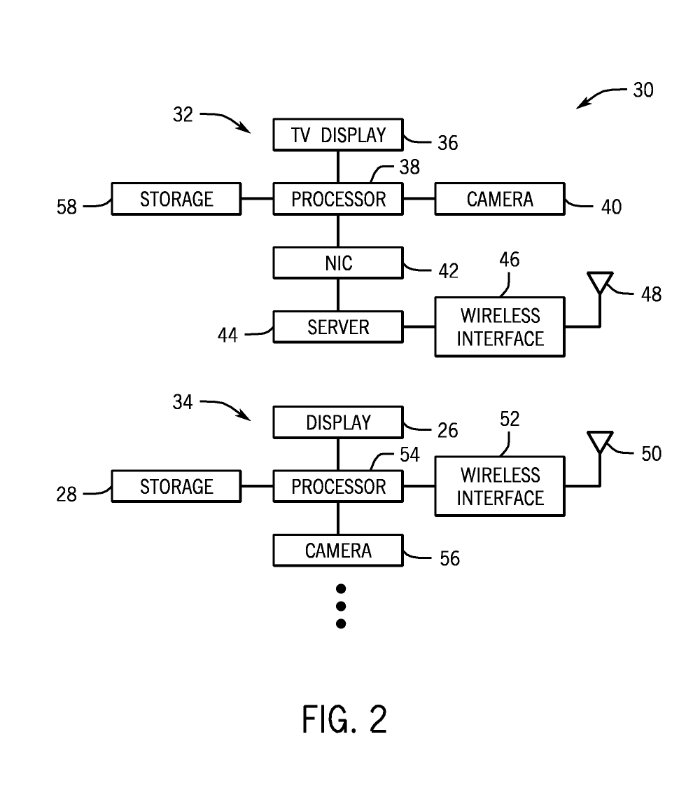

Referring to FIG. 2, in accordance with one embodiment, televisions or entertainment devices and the mobile devices may be part of a network. In some embodiments, multiple entertainment devices such as televisions, video or audio playback systems or games may be part of a network. The network may be a wired network or a wireless network, including a network based on short range wireless technology as one example, or a mixture of wired and wireless devices as another example.

Thus the network 30 in one embodiment may include a television 32 that includes a television display 36. The television 32 may include a processor 38 coupled to a storage 58 and a camera 40. A network interface card (NIC) 42 may also be coupled to the processor 38.

The network interface card 42 may enable a wired or wireless network connection to a server 44 which, in one embodiment, may be another computer system or a home server as two examples. The server 44 may be coupled to a wireless interface 46 in turn coupled to an antenna 48.

The antenna 48 may enable wireless communication with a user's mobile device 34. The mobile device 34 may include an antenna 50 coupled to a wireless interface 52. The wireless interface 52 may be coupled to a processor 54. The processor 54 may then in turn be coupled to a camera 56, a storage 28 and a display 26 in one embodiment. Many more mobile devices may be coupled to the network as well as well as many more television displays, media playback devices, or games devices, to mention a few examples.

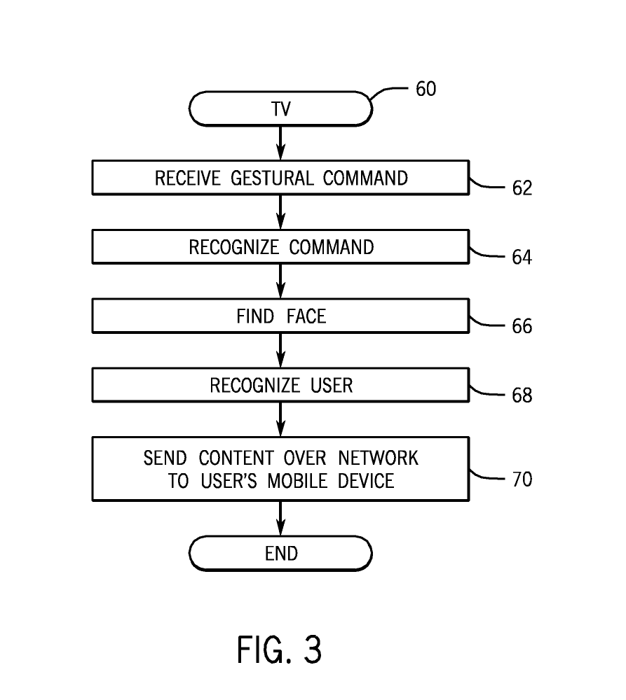

Referring to FIG. 3, in accordance with one embodiment, a sequence 60 may be implemented by the television receiver 32. The sequence 60 may be implemented in a software, firmware, and/or hardware. In software and firmware embodiments it may be implemented by computer executed instructions stored in one or more non-transitory computer readable media such as a magnetic, semiconductor or optical storage media.

In some embodiments, the sequence may be implemented locally on the television receiver. In other embodiments the sequence may be implemented by a local server coupled to the television. In still other embodiments, the sequence may be implemented by a server connected, for example, over the Internet, such as a cloud server.

The sequence 60 begins by receiving a gestural command via images captured by the camera 40, as indicated at block 62. The command can then be recognized, as indicated in block 64, by comparing the image from the camera 40 to stored information associated with particular commands and determining which command matches the received image. This may be done using video analytics, in some embodiments.

Then a hand gestural command may be associated with the user's face, in some embodiments, by tracking the user's hand back to the user's face as indicated by block 66. In one embodiment this may involve recognizing the user's arm connected to the hand, the user's body connected to the arm, and the user's head or face connected to the body using image recognition techniques and video analytics.

Thus once the user's face is found, the user may be recognized by comparing an image obtained during a training sequence with the image obtained by the camera 40 associated with the television receiver at the time of receiving the gestural command as indicated in block 68.

Then, in some embodiments, the television receiver may take an action dependent upon the recognition of the user and the gestural command. Namely in one embodiment, content may be sent over the network 30 to the user's mobile device 34 as indicated in block 70. Thus even when multiple users are present in front of the television, the system can identify a particular user that made the command without requiring the users to stand in particular positions or to take particular unnatural courses of action. Moreover, the television can sync (i.e., link) a user gestural command to both a face and a mobile device in some embodiments.

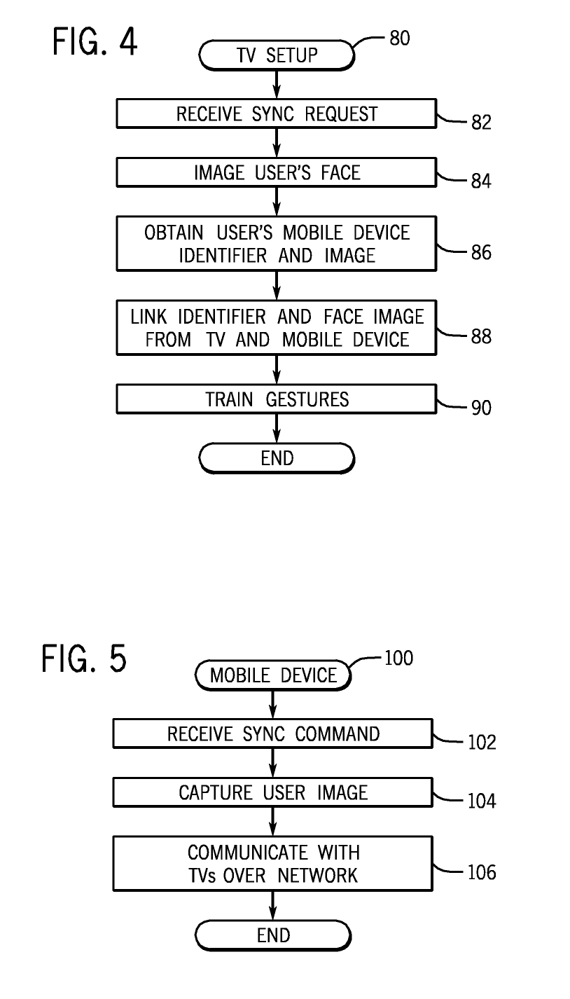

Turning next to FIG. 4, a television set-up sequence 80 may be implemented in software, firmware and/or hardware. In software and firmware embodiments it may be implemented by computer executed instructions stored in one or more non-transitory computer-readable media such as a semiconductor, magnetic or optical storage. In some embodiments, the set-up sequence enables the sequence depicted in FIG. 3 and so may be implemented before actually using the system to receive and process gestural commands. For example a training sequence may be required in order to receive and distinguish gestural commands in some embodiments.

The set-up sequence 80 shown in FIG. 4 begins by receiving a request for synchronization or linking between the user's mobile device and the television receiver as indicated in block 82. In such case, an image may be captured of the user's face using the television's camera 40 indicated in block 84. At the same time the user's mobile device may provide an identifier for the user and an image taken by the user's mobile device as indicated in block 86. As indicated in block 88 the identifier may be linked to the facial image taken from the television and matched with that from the mobile device.

Then as indicated in block 90, the various gestures which the user may wish to use may be trained. For example, the user may go through a series of gestures and then may indicate what each of these gestures may be intended to convey. The identification of the gestures may be entered using the mobile device, a television remote control or any other input device. For example the user may have a user interface where the user clicks on a particular command and is prompted to select the appropriate gestural command that the user wishes to associate with that command. For example, a drop down menu of possible commands may be displayed.

Turning finally to FIG. 5, a mobile device sequence 100 may be implemented in software, firmware and/or hardware. In software and firmware embodiments it may be implemented by computer executed instructions stored on one or more non-transitory computer readable media such as a magnetic, semiconductor or optical storage.

The mobile device sequence 100 begins by receiving the synchronization command from the user as indicated in block 102. In response, the system may automatically capture the user's image on the mobile device as indicated in block 104. A graphical user interface may warn or prepare the user for the image capture. Specifically, the user may be asked to aim the mobile device camera to take a portrait image of the user's face. Then this image and identifier are communicated to one or more televisions, media playback devices or games over the network as indicated in block 106.

The following clauses and/or examples pertain to further embodiments:

1. A method comprising:
associating a hand gestural command from one person of a plurality of persons by associating a hand with a face using computer video analysis of the one person's hand, arm and face.

2. The method of clause 1 including capturing an image of a first and second person; and
using computer video analysis to determine whether a hand gesture was made by the first or the second person.

3. The method of clause 2 including identifying an arm, body and face connected to the hand making a recognizable gesture.

4. The method of clause 3 including using facial recognition to identify the one person.

5. The method of clause 1 including capturing an image of said user in a first computer.

6. The method of clause 5 including capturing an image of the user using a first computer to associate the hand gestural command with the user.

7. The method of clause 6 including receiving an image of the user from a second computer.

8. The method of clause 7 including comparing said images from different computers.

9. The method of clause 8 including associating at least one of said images with said first person and said second computer.

10. The method of clause 9 including sending a message to said second computer.

11. The method of clause 1 including displaying television.

12. The method clause 11 including enabling said television to be controlled by gestural commands.

13. The method of clause 12 including enabling a television signal to be sent from said television to a device associated with said one person, in response to a gestural command.

14. A method comprising:
enabling a mobile device to link to a television;
enabling the television to recognize a human gestural command; and
enabling the television to transmit television content to said mobile device in response to said command.

15. The method of clause 14 including enabling said television to distinguish gestural commands from different users using facial recognition.

16. The method of clause 14 including enabling the television to compare an image of a user from the mobile device to an image of the user captured by the television.

17. The method of clause 14 including enabling said television to communicate over a network with said mobile device.

18. The method clause 15 including enabling said television to analyze an image of two persons and to determine which person is connected to a hand making a gestural command.

19. The method of clause 14 including using an image received from said mobile device to link the mobile device to said television.

20. The method of clause 19 including capturing an image of a user and comparing said image to an image received from said mobile device.

21. The method of clause 20 including using said images to identify a user making a gestural command.

22. The method of clause 14 including enabling recognition of a hand gestural command.

23. At least one computer readable medium storing instructions that in response to being executed on a computing device cause the computing device to carry out a method according to any one of clauses 1 to 22.

24. An apparatus to perform the method of any one of clauses 1 to 22.

25. The apparatus of clause 24 wherein said apparatus is a television.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
associating a hand gestural command from one person of a plurality of persons by associating a hand with a face using computer video analysis of the one person's hand, arm and face.

2. The method of claim 1 including capturing an image of a first and second person; and
using computer video analysis to determine whether a hand gesture was made by the first or the second person.

3. The method of claim 2 including identifying an arm, body and face connected to the hand making a recognizable gesture.

4. The method of claim 3 including using facial recognition to identify the one person.

5. The method of claim 1 including capturing an image of said user in a first computer.

6. The method of claim 5 including capturing an image of the user using a first computer to associate the hand gestural command with the user.

7. The method of claim 6 including receiving an image of the user from a second computer.

8. The method of claim 7 including comparing said images from different computers.

9. The method of claim 8 including associating at least one of said images with said first person and said second computer.

10. The method of claim 9 including sending a message to said second computer.

11. The method of claim 1 including displaying television.

12. The method claim 11 including enabling said television to be controlled by gestural commands.

13. The method of claim 12 including enabling a television signal to be sent from said television to a device associated with said one person, in response to a gestural command.

14. A method comprising:
enabling a mobile device to link to a computer;
enabling the computer to capture an image of a user; and
enabling the computer to link a mobile device and the image.

15. The method of claim 14 including enabling a computer that is a television receiver to capture a user's image.

16. The method of claim 15 including enabling the television to recognize a human gestural command and to send information to said mobile device in response to detection of the image and the gestural command.

17. The method of claim 16 including enabling said television to distinguish gestural commands from different users using facial recognition.

18. The method of claim 16 including enabling the television to compare an image of a user from the mobile device to an image of the user captured by the television.

19. The method of claim 15 including enabling said television to communicate over a network with said mobile device.

20. The method claim 17 including enabling said television to analyze an image of two persons and to determine which person is connected to a hand making a gestural command.

21. The method of claim 14 including using an image received from said mobile device to link the mobile device to said television.

22. The method of claim 19 including capturing an image of a user and comparing said image to an image received from said mobile device.

23. The method of claim 20 including using said images to identify a user making a gestural command.

24. The method of claim 14 including enabling recognition of a hand gestural command.

25. At least one computer readable medium storing instructions that in response to being executed on a computing device cause the computing device to carry out a method according to claim 24.

26. An apparatus to perform the method of claim 24.

27. The apparatus of claim 26 wherein said apparatus includes a television.
